(19) United States
(12) Patent Application Publication
(10) Pub. No.: US 2026/0035300 A1
(43) Pub. Date: Feb. 5, 2026

(54) SORTING METHOD AND METHOD FOR RECYCLING MOLDED REFRACTORY PRODUCTS, PREFERABLY STONES, AND THEIR USE

(71) Applicant: Refratechnik Holding GmbH, München (DE)

(72) Inventors: Petra Stein, München (DE); Hans-Jürgen Klischat, München (DE); Thomas Schemmel, München (DE); Rainer Gaebel, München (DE)

(21) Appl. No.: 18/994,709

(22) PCT Filed: Aug. 2, 2023
(86) PCT No.: PCT/EP2023/071408

§ 371 Date: Jan. 15, 2025

(30) Foreign Application Priority Data
Aug. 10, 2022 (DE) 10 2022 120 180.5

(51) Int. Cl. C04B 18/165; B07C 5/34

(52) U.S. Cl. CPC C04B 18/165; B07C 5/34

(57) ABSTRACT

A sorting method and a method for recycling preferably coarse ceramic, refractory, shaped products, preferably bricks, and use of the sorted or recycled products.

### CROSS REFERENCE TO RELATED APPLICATIONS

This application is a 35 U.S.C § 371 national phase application of International Application No. PCT/EP2023/071408, filed on Aug. 2, 2023, which claims the benefit of priority under 35 U.S.C. § 119 to German Patent Application No.: 10 2022 120 180.5, filed Aug. 10, 2022, the contents of which are incorporated herein by reference in their entirety.

### FIELD

The present invention relates to a sorting method and a method for recycling, preferably coarse ceramic, refractory, shaped products, preferably bricks, and to the use of the sorted or recycled products.

### BACKGROUND

The statements in this section provide background information related to the present disclosure, definitions for terms used in the present disclosure, and other basic information regarding the present invention in order to provide a better understanding of the overall disclosure. In doing so, these statements may not constitute prior art.

In the context of the present disclosure, the term “refractory” is not intended to be limited to the definition according to ISO 836 or DIN 51060, which define a pyrometric cone equivalent of >1500° C. Refractory products in the sense of the present disclosure comprise a compression softening point T_{0.5} according to DIN EN ISO 1893:2008-09 of T_{0.5}≥600° C., preferably T_{0.5}≥800° C. Accordingly, refractory or fire-resistant grainy materials or granular materials in the sense of the present disclosure are those materials or granular materials that are suitable for a refractory product with the above-mentioned compression softening point T_{0.5}.

Refractory products are used for the protection of aggregate constructions in aggregates in which temperatures between 600 and 2000° C., in particular between 800 and 1800° C., predominate.

In particular, they are used for the refractory cladding (lining) of plants for thermal processes, preferably melting, firing and heat treatment plants or transport vessels. However, they can also be functional products (see “Gerald Routschka/Hartmut Wuthnow, Praxishandbuch “Feuerfeste Werkstoffe”, 6th edition, Vulkan-Verlag (hereinafter referred to simply as “Practical Handbook”), Chapter 1.6).

The refractory lining of a plant or a transport vessel, which lines the shell of the plant or transport vessel, can be single-layered or multi-layered, and is usually multi-layered. The lining comprises a working casing or wear casing on the fire side or inside of the aggregate, which wears out during use and must be replaced regularly. If the wear casing consists of refractory bricks, in particular their fire side is used up during use. However, at least a part of the bricks can be reused after use and is mechanically broken out of the wear casing for this purpose.

In addition, the lining can comprise a permanent casing that follows the wear casing. The permanent casing then remains in the plant or the transport vessel for several furnace trips or cycles and serves as a safety casing. The permanent casing can also be followed by an insulating backing.

Coarse ceramic products are known to be products made from granular materials having grain sizes of up to 6 mm, in special cases also up to 25 mm (Practical Handbook, Chapter 2). Coarse ceramics are distinguished from fine ceramics by the grain size of the microstructure components. If the microstructure components are at least partially larger than 1 mm, the product is a coarse ceramic product; if the microstructure components are exclusively ≤1 mm, it is fine ceramics.

Furthermore, within refractory products a distinction is made between non-basic (Practical Handbook, 4.1) and basic products (Practical Handbook, 4.2). According to DIN EN ISO 10081:2005-05, a distinction is made between non-basic and basic refractory products, based in particular on the chemical reaction behavior. The product group of non-basic products includes the materials of the SiO₂—Al₂O₃ series and other materials that cannot be classified more precisely according to their chemical reaction behavior, such as SiC and carbon products. An essential feature of most basic products is that the sum of the oxides MgO and CaO predominates. In addition, chromite, picrochromite, spinel and forsterite bricks are classified as basic products, although they are almost neutral.

In the case of coarse ceramic products, a distinction is also made between shaped and unshaped products.

Shaped coarse ceramic products are unfired, possibly tempered, or ceramically fired products, preferably produced in a ceramic factory, in particular bricks or plates. They have a defined geometry and are ready for installation. Shaping is carried out, for example, by pressing, stamping, ramming or slip casting. The shaped products, in particular the bricks, are walled with mortar or without mortar (“crunch”), e.g. to form the lining. The production process of coarse ceramic shaped products is usually divided into the following steps (Practical Handbook, page 14/point 2.1):
preparation;
mixing;
shaping;
drying, if necessary;
(if necessary) thermal treatment up to 800° C. or firing; and
post-treatment (if necessary).

Unshaped products (Practical Handbook, page 142/point 5) are products that are formed into their final shape, usually at the user's site, from an unshaped fresh mass or from lumps, e.g. by casting, vibrating, poking, stamping or gunning. Unshaped products are usually placed behind formwork in larger fields at the place of use and, after hardening, form part of the lining. For example, unshaped products are gunning masses, stamping masses, casting masses, vibrating masses or grouting masses.

The recycling of refractory products is becoming increasingly important for economic and ecological reasons and also due to the scarcity of resources. The reuse of recycled materials (recyclates) for the production of new refractory products brings with it the advantages of cheaper raw materials, lower processing costs, lower energy consumption and reduced carbon dioxide emissions compared to primary raw materials.

To reuse the broken-out products, however, they must be sorted by type. This is because there is usually a mixture of different product types after the lining has been broken out. Depending on the place and time of use, the products have also been subjected to different stresses and may have undergone chemical/mineral changes, so that not all products are suitable for reuse or are suitable for the manufacture of different products. The broken-out products may be contaminated, for example, by infiltration and/or adhesion of/with slag, molten clinker, metals, salts or other process media.

In order to separate the broken-out products on the basis of their chemical/mineral composition, it is well known in the field to carry out a chemical analysis of the products using laser-induced breakdown spectroscopy (LIBS) (see e.g. https://cordis.europa.eu/article/id/197342-how-to-turn-refractory-waste-back-into-raw-materials/de). By means of a multi-element analysis a classification of different refractory materials is carried out. In particular, the main constituents and some aggregates can be determined.

However, the refractory products cannot always be fully chemically/minerally characterized using this method. For example, it is not possible to clearly determine whether the refractory products contain carbon. This is due to the fact that the refractory products change on the surface during use. The carbon burns out on the fire side of the products. As the penetration depth for the LIBS measurement is usually limited to a few 100 μm, it can therefore happen that no carbon is detected even though the product contains carbon.

Furthermore, it is known in the field to provide refractory products with a sensor or a chip for various purposes.

WO 2008/135135 A2, for example, discloses a ceramic component which comprises an integrated sensor for data acquisition and transmission, the information acquired being identification of the component, physical properties of the component, movements of the component, time of use of the component or location of the component. The task is to enable identification and statements to be made about the condition or operating time of the component before, during and after use. The information for identifying the component includes, for example, the product type, material types, manufacturer details, date of manufacture, date of delivery and date of use. In particular, for example, temperature measurements and measurements of mechanical stresses as a function of time shall be used to predict the wear condition of the component so that it is replaced in good time, but not too early. WO 2008/135135 A2 does not deal with the recycling of the components.

WO 2020/254134 A1 also deals with the use of sensors, e.g. RFID chips, in refractory components, e.g. slide gate valve plates. This concerns the monitoring and tracking of replaceable refractory components in a metallurgical plant.

EP 3 119 915 B1 discloses a metallurgical container with a transponder that can be read wirelessly.

WO 2010/057656 A1 deals with a device for actively tracking specific data relating to systems or their components of a metallurgical plant, wherein at least one writable and readable storage medium, e.g. an RFID chip, for the specific data is permanently connected to each component and the specific data can be changed periodically and/or in response to input. The data includes physical and/or mechanical and/or chemical properties of the components, among others.

DE 203 06 019 U1 discloses a sorting machine using transponders, wherein specific objects are specifically separated from a stream of items to be sorted and the information relevant for sorting is obtained by means of a radio frequency identification system. Thereby, those objects that are equipped with a transponder and are within the detection range of at least one reader are identified. The relevant information is, for example, information on material composition and/or use and/or production. The sorting machine is used to sort plastic bottles made of a specific material and silicone cartridges out of used packaging such as plastic bottles. At least those objects that are to be sorted out carry a transponder.

One objective of the present disclosure is to provide a sorting method for sorting, preferably coarse ceramic, refractory, shaped products, preferably bricks, which have been preferably used in an aggregate, preferably a furnace, and broken out thereof after use, which ensures efficient and exact sorting of the broken-out products.

Additional objectives of the present disclosure are to provide a method for recycling the broken-out products and to provide a use for the broken-out products.

### SUMMARY

The above-mentioned objectives are solved by a sorting method for sorting, preferably coarse ceramic, refractory, shaped products, preferably bricks, wherein the method comprises sorting the products at least on the basis of their mineral and/or chemical composition. The products comprise a transponder which is read out for sorting and the products are sorted at least with regard to their mineral and/or chemical composition on the basis of or by processing the read-out information, wherein the products are
a) at least partially products used in an aggregate, preferably a furnace or a transport vessel, and broken out of this after use, and/or
b) at least partially products that are unusable for use, in particular waste products that incur during manufacture and/or products that have changed, preferably hydrated, during storage and/or transport.

According to another aspect of the present the objectives of the present disclosure are also addressed by a method for recycling coarse ceramic refractory shaped products, preferably bricks, used in an aggregate, preferably a furnace or a transport vessel, comprising the following method steps:
a) Breaking out the products of the aggregate, preferably the furnace,
b) Sorting the broken-out products at least on the basis of their mineral and/or chemical composition, and
c) Preferably reprocessing the sorted products,
wherein the broken-out products comprise a transponder and are sorted according to the sorting method described above and further defined herein.

According to another aspect of the present disclosure, a method for reusing products sorted according to the sorting method described above and further defined herein for the production of, preferably, coarse ceramic, refractory, shaped or unshaped products, is provided.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the description may be well understood, the present disclosure is explained in more detail below with reference to the accompanying drawings, in which:

FIG. 1: Schematically shows the life cycle of refractory, fired products with recycling according to one aspect of the present disclosure;

FIG. 2: Schematically shows the life cycle of refractory, unfired products with recycling according to one aspect of the present disclosure; and

FIG. 3: Schematically shows a cross-section of a refractory brick with an integrated transponder according to another aspect of the present disclosure.

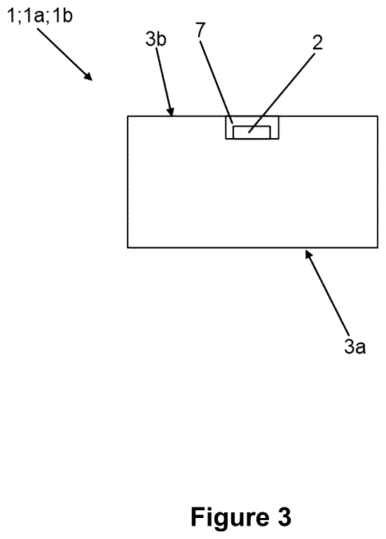

The drawings are provided herewith for purely illustrative purposes and are not intended to limit the scope of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the present disclosure provides a sorting method and a method for recycling, preferably coarse ceramic, refractory, shaped products, preferably bricks, and to the use of the sorted or recycled products.

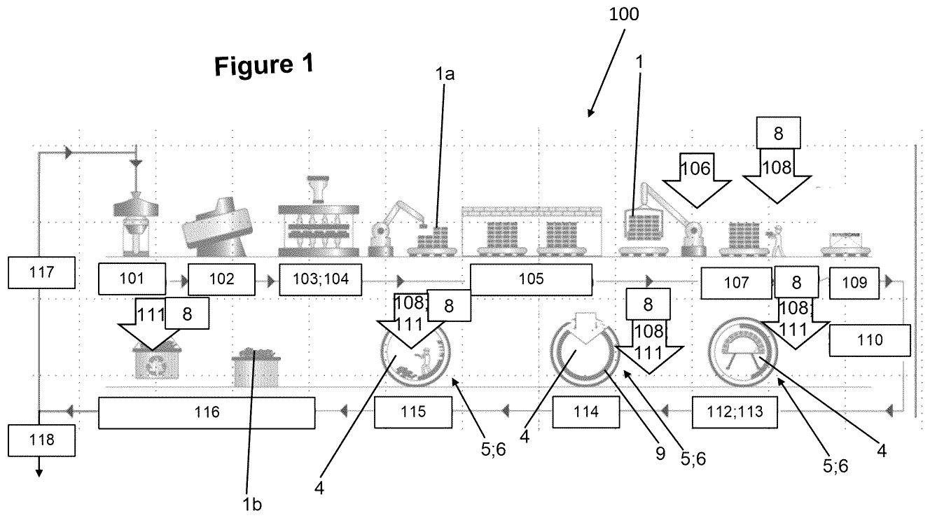

Referring to FIG. 1 the life cycle 100 of refractory, shaped, fired products 1 is schematically shown.

Accordingly, at first, processing 101 of the raw materials used for production takes place in a known manner. These are primary raw materials and secondary raw materials. After that, mixing 102 of the processed raw materials and shaping 103, preferably pressing 104, of the mixture to form shaped, unfired products 1a takes place. Ceramic firing 105 of the shaped, in particular pressed, unfired products 1a then takes place in a furnace.

According one aspect of the present disclosure, after firing, providing or equipping 106 of the fired products 1 with at least one transponder 2 takes place. After that, preferably, a quality control 107 of the fired products 1 is carried out.

A transponder 2 is known to be a radio communication device that receives incoming signals and automatically responds or forwards them. As is known, a transponder 2 can receive information from and/or transmit information to a transmitter and/or receiver unit 8 in a contactless process.

The transponder 2 comprises a coupling element, e.g. an antenna and a microchip, in a manner known per se. The microchip comprises an analog circuit for receiving and transmitting (transceiver) as well as a digital circuit, preferably a microcontroller, and a memory. The memory is a memory that can be written to at least once. The memory contains the unchangeable, in particular unique, identity of the transponder 2. Preferably, however, it is a rewritable memory so that information can be stored and/or changed again and again during the service life of the transponder 2.

According to another aspect of the present disclosure, the transponder 2 is preferably a passive transponder 2.

As is known, a passive transponder 2 draws the energy required for communication and for the execution of internal processes exclusively from the electromagnetic field of the transmitter and/or receiver unit 8.

Preferably, the transponder 2 is also an RFID (radio-frequency identification) transponder 2.

In addition, the transponder 2 preferably comprises means for measuring temperature and/or means for measuring humidity.

Furthermore, the unfired and fired products 1;1a comprise a product fire side or product hot side 3a and a product cold side 3b opposite this. When the products 1 are installed, the product hot side 3a faces a fired aggregate interior or fire chamber 4 of an aggregate 5, preferably a furnace 6. The product cold side 3b faces away from the fire chamber 4.

Preferably, the transponder 2 is arranged or positioned or fastened in a cutout or recess 7 in the product cold side 3b of the product 1. The arrangement on the product cold side 3b ensures that the temperature load on the transponder 2 during use is as low as possible. The arrangement of the transponder 2 in the recess 7 also ensures mechanical protection of the transponder 2. In particular, it is ensured that the transponder 2 is not damaged during handling of the products 1 during transportation and during installation and removal of the product 1.

According to another aspect of the present disclosure, applying 108 of product-specific information to the transponder 2 by means of a transmitter/receiver unit 8 known per se is now carried out, whereby at least information relating to the chemical and/or mineral composition of the respective product 1 is applied or stored. Preferably, the product-specific information is the recipe. The recipe contains all the materials used to manufacture the product, i.e. in particular also the main and secondary components used, in particular the additives. Preferably, the recipe also contains information regarding the chemical composition of the materials used, in particular the content of impurities, such as the iron content. In particular, the presence and amount of additives cannot be readily determined using known methods.

Furthermore, at least one of the following pieces of information is preferably applied or stored:
Production date;
Internal recipe number;
Information on the manufacturing process, in particular the mixing time and/or the pressing pressure and/or the firing temperature;
Waste code number; and
A pallet number for tracking.

Using the production date in combination with the recipe number, for example, the materials used for production and their composition can also be determined if the associated data is stored in a database. It is then not necessary to store the complete recipe on the transponder 2.

After the application 108 of the information, packaging 109 of the fired products 1 and transporting 110 to the place of use takes place.

After arrival at the place of use, applying 108 of further information to the transponder 2 and/or reading out 111 of information may take place.

In particular, the information read out can be taken over by the goods management systems of the plant operators.

After that installation or installing 112 of the products 1 in the aggregate 5 takes place. In particular, refractory lining or cladding 113 of the aggregate 5 with the refractory products 1 takes place. The refractory products 1 are preferably used either to produce a wear casing or a permanent casing or an insulating backing. After installation 112, they therefore form part of a lining 9 of the aggregate 5, in particular part of the wear casing or the permanent casing or the insulating backing.

Before or after installation 112, further applying 108 of information to the transponder 2 preferably takes place, in particular of information relating to the place of use, in particular the aggregate 5 per se, and preferably the zone in the aggregate 5, preferably in the furnace 6, and/or the assembly method. With regard to the assembly method, in particular information can be applied as to whether the products 1 are mortared together or not.

After that, use 114 of the products 1 in the aggregate 5, preferably in the furnace

6, takes place.

If the transponders 2 are set up for this purpose, a preferably continuous temperature measurement and/or a humidity measurement and/or an atmosphere measurement is preferably carried out by the respective transponder 2 during use, i.e. in-situ. The transponder 2 also stores these measurement results.

After a certain period of use, breaking-out or break-out 115 of the products 1 out of the aggregate 5, preferably out of the furnace 6, is carried out.

Preferably, after breaking-out 115, a further application 108 of information to the transponder 2 of the broken-out products 1b is carried out, in particular of information relating to the use 114 of the products 1, preferably of information about the time of use and/or the temperature regime in the aggregate interior or fire chamber 4 and/or the atmosphere in the aggregate interior or fire chamber 4, in particular the alkali content of the atmosphere and/or the material produced or processed in the aggregate 5, preferably the furnace 6, and/or the raw materials used for this purpose.

This is because by means of the information about the use of the products 1 predictions about the mineral and/or chemical composition of the broken-out products 1b can also be made, if they are stressed in such a way that they change during use.

Subsequently, sorting 116 of the broken-out products 1b takes place. According another aspect of the present disclosure, sorting 116 is carried out, inter alia, on the basis of the information contained on the transponder 2 relating to the mineral and/or chemical composition of the products 1b. For this purpose, reading out 111 of the information from the transponder 2 takes place prior to sorting 116.

The information read out is processed by means of a data processing program or by a data processing system and/or by an operator and used for sorting.

In particular, during sorting 116 a classification of the products 1b into different material fractions takes place. Depending on whether the material fractions are reusable or not, either a return 117 and a reuse of the products 1b or a disposal 118 in accordance with the law takes place.

For reuse, the reusable products 1b are again supplied to the manufacturing process for the production of new refractory products 1, in particular reprocessed.

The reusable products 1b can be used either for the manufacture of products 1 of the same product type or other refractory products. For example, they can also be used for the manufacture of unshaped refractory products (not shown).

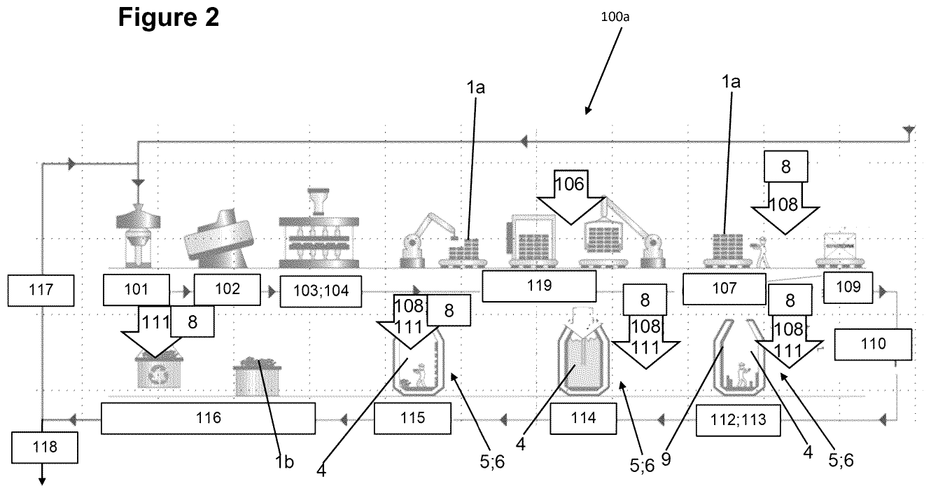

FIG. 2 shows a life cycle 100a of unfired, shaped refractory products 1a.

In contrast to the fired products 1, only a heat treatment 119 at up to a maximum of 800° C. is preferably carried out instead of firing 105. The unfired products 1a are then fired in situ during use 114 in a manner known per se.

In particular for unfired products 1a, information about the use is advantageous for sorting, as these usually change chemically and/or minerally during use.

Furthermore, according one aspect of the present disclosure, fired or unfired products 1;1a that were not used in an aggregate 5 but still have to be recycled are also sorted.

In particular, products 1;1a must be recycled if they have exceeded their use-by time or have been altered for other reasons during storage or transportation in such a way that they can no longer be used, i.e. are unusable. For example, it may happen that magnesia bricks are exposed to high humidity for too long during storage or transport, causing them to hydrate and render them unusable.

This can be determined, for example, by reading the transponder 2 if it has means for measuring humidity.

In addition, waste that incurs during manufacture of the products 1;1a or products 1;1a resulting from overproduction must be recycled.

Due to the sorting 116 based on the information contained on the transponder 2 or the information(s) read out from it, the method according to the present disclosure ensures a sorting 116 by type, an efficient and reliable sorting 116. No error-prone and time-consuming laser-optical determination of the chemical and/or mineralogical composition of the products 1;1a;1b and/or manual sorting is necessary. A much finer or more detailed sorting 116 can also be carried out. This is because the transponder 2 can contain not only information regarding the main components, but also the secondary components, e.g. also regarding the binder and additives, so that it can also be sorted based on this. This means that the quality of the recyclates can be improved even further.

The method according to the present disclosure also makes it possible to classify the products 1;1a;1b not only according to the chemical and/or mineralogical composition, but also, for example, according to the origin of the raw material and/or according to the influence of the use on the product.

Unlike barcodes, for example, the transponders 2, preferably the RFID transponders, can also be read even if optical methods cannot be used. In addition, as described, information can be recorded and output from successive processes in several steps. Preferably, data is even recorded in-situ as explained, which can be used for sorting 116.

Of course, it is also within the scope of the present disclosure that the transponders 2 already contain information, in particular product-specific information, before they are attached to the refractory product 1;1a. The information can also be applied to the transponder 2 before the quality control 107. It is only important that it is present on the transponder 2 before the installation 112 of the products 1;1a.

It is also possible that the transponders 2 only contain a labeling for uniquely identifying the product 1;1a without any further product-specific information. The sorting criteria used for sorting are then not directly readable.

The assignment of the labeling to the product properties, in particular the recipe, is then only carried out by data processing after the transponder 2 has been read. In this case, for example, all the necessary product-specific information, in particular the recipe, for the respective product 1;1a is stored in a database.

This also applies to all other information. In principle, the sorting criteria used for sorting do not have to be directly readable from the transponder 2. Instead, information can be stored on the transponder 2, which is read out, and the sorting criteria assigned to the information and any other information are stored in a database. As already explained, the information stored on the transponder 2 may, for example, be the recipe number or other information for uniquely identifying the product 1;1a.

In this case, the transponder 2 can also be a simpler transponder 2 with only a microprocessor without rewritable memory or an SAW (surface acoustic waves) transponder.

Finally, it is pointed out that all of the above-mentioned, in particular claimed, features of the sorting method and/or the recycling method are particularly advantageous in themselves and in any combination and are the subject of the present invention.

In particular, all the aforementioned information read from the transponder and/or all the information used to process the information read from the transponder can be combined with each other in any combination.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A sorting method for sorting, preferably coarse ceramic, refractory, shaped products, preferably bricks, wherein the method comprises sorting the products at least on the basis of their mineral and/or chemical composition,
wherein, the products comprise a transponder which is read out for sorting and the products are sorted at least with regard to their mineral and/or chemical composition on the basis of or by processing the read-out information,
and that the products are
a) at least partially products used in an aggregate, preferably a furnace or a transport vessel, and broken out of this after use, and/or
b) at least partially products that are unusable for use, in particular waste products that incur during manufacture and/or products that have changed, preferably hydrated, during storage and/or transport.

2. The sorting method according to claim 1, wherein the method includes sorting criteria on the basis of which the products are sorted; the sorting criteria being read directly from the transponder and/or are determined by means of data processing from the information read from the transponder.

3. The sorting method according to claim 1, wherein the transponder comprises the information relating to the mineral and/or chemical composition of the product and the products are sorted at least on the basis of this information.

4. The sorting method according to claim 1, wherein the information read from the transponder and/or the information used to process the information read from the transponder is one or more of the following:
Recipe;
Production date:
Internal recipe number:
Information on the manufacturing process of the products, in particular the mixing time and/or the pressing pressure and/or the firing temperature;
Waste code number;
Place of use of the products;
Operating time of the products;
Temperature regime in a plant interior of an aggregate, preferably a furnace, in which the products were used;
Atmosphere in the plant interior of the aggregate, preferably of the furnace, in which the products were used, in particular alkali content of the atmosphere; and
Pallet number.

5. The sorting method according to claim 1, wherein the products comprise an RFID transponder as the transponder.

6. The sorting method according to claim 1, wherein the products comprise a passive transponder as the transponder.

7. The sorting method according to claim 1, wherein the transponder is configured for temperature measurement and/or for humidity measurement and/or for atmospheric measurement.

8. The sorting method according to claim 1, wherein the transponders are each arranged in a recess in a product cold side of the broken-out product.

9. The sorting method according claim 1, wherein the broken-out products are products of a refractory lining and/or functional products.

10. A sorting method according to claim 1, wherein some of the products are products from overproduction.

11. A method for recycling coarse ceramic refractory shaped products, preferably bricks, used in an aggregate, preferably a furnace or a transport vessel, comprising the following method steps:
a) Breaking out the products of the aggregate, preferably the furnace,
b) Sorting the broken-out products at least on the basis of their mineral and/or chemical composition, and
c) Preferably reprocessing the sorted products,
wherein the broken-out products comprise a transponder and are sorted according to the sorting method according to claim 1.

12. A method for reusing products sorted according to the sorting method according to claim 1 for the production of, preferably, coarse ceramic, refractory, shaped or unshaped products.

13. (canceled)

14. (canceled)

15. A method for reusing products recycled according to the method of claim 11 for the production of, preferably, coarse ceramic, refractory, shaped or unshaped products.
